(19) United States
(12) Patent Application Publication
(10) Pub. No.: US 2014/0175755 A1
(43) Pub. Date: Jun. 26, 2014

(54) SHAFT SEAL RING WITH ANTI-ROTATION FEATURES

(71) Applicant: Parker-Hannifin Corporation, Cleveland, OH (US)

(72) Inventor: Berndt L. Luchs, Rustburg, VA (US)

(21) Appl. No.: 14/104,072

(22) Filed: Dec. 12, 2013

Related U.S. Application Data
(60) Provisional application No. 61/740,767, filed on Dec. 21, 2012.

(51) Int. Cl. F16J 15/34

(52) U.S. Cl. CPC F16J 15/34
USPC 277/500

(57) ABSTRACT

A shaft seal includes an elastomeric component that includes a plurality of anti-rotation features spaced intermittently about a circumference of the elastomeric component, and a seal contact component that is bonded to the elastomeric component. Each of the plurality of anti-rotation features is a rib structure. The rib structure of each of the plurality of anti-rotation features may extend from adjacent the outer diameter face and widen toward the inner diameter face, or may extend from adjacent the inner diameter face and widen toward the outer inner diameter face, to form substantially a tear drop shape. A shaft seal assembly includes the described shaft seal, and an application housing structure including a bore that receives at least a portion of the shaft seal. The seal contact component is received within the bore, and the application housing structure is configured to rotate relative to the shaft seal.

### FIELD OF THE INVENTION

The present invention is directed to a seal configured for use in high rotational speed and high fluid pressure applications, and particularly to a bi-material shaft seal ring having anti-rotation features.

### BACKGROUND OF THE INVENTION

Various sealing applications are provided in high rotational, high fluid pressure environments. Examples of such environments include automotive and light truck automatic transmission systems, limited slip differential clutch systems in engine transmissions, tire inflation systems, and the like. Such systems require rotating shaft seals to seal fluids, such as oils or air, operating under high pressure.

In conventional shaft seals, a bi-material seal ring is provided in which an elastomeric component is bonded to a substantially rigid or semi-rigid seal contact component. The seal contact component preferably is a low-friction material. In operation, the seal is positioned within an application groove or bore, and the application groove or bore typically rotates relative to the seal at a high rotational speed. The seal operates to seal in operational fluids under high pressure, such as hydraulic fluids, high-pressure air, and the like, to prevent leakage during application performance.

In such conventional shaft seals, a circumferential anti-rotation ring of material may be provided, attached to or as part of the elastomeric component. Such circumferential anti-rotation ring provides an interference surface that prevents rotational slippage of the seal within the application groove or bore. The conventional configuration, however, has proven deficient.

In particular, the large interference surface tends to experience a high level of wear, ultimately compromising the integrity of the seal. Rotational slippage may therefore occur, resulting in even further wear of the seal and ultimately a loss of seal integrity. Leakage of fluids from the application structure may then occur. Accordingly, conventional shaft seals undesirably must be replaced frequently to avoid the negative consequences of seal degradation. In addition, circumferential anti-rotation rings have a substantial seal volume as compared to the void volume within the application housing structure, and therefore “over-stuffing” of seal material within the shaft often occurs. Such over-stuffing of the seal material exacerbates the wear problems of conventional shaft seal rings.

### SUMMARY OF THE INVENTION

The present invention provides an improved rotational shaft seal ring for use in applications involving high rotational speeds and high pressure fluids. The shaft seal ring of the present invention reduces seal wear as compared to conventional configurations, while maintaining an effective seal against leakage of the operating fluids of the application.

Accordingly, an aspect of the invention is a shaft seal with enhanced anti-rotation features. In exemplary embodiments the shaft seal is a bi-material seal ring including an elastomeric component bonded to a seal contact component. The seal contact component is a rigid or semi-rigid material, such as for example polytetrafluroethylene (PTFE), commonly sold under the trade name Teflon®. The PTFE component material accommodates the high rotational speed and high fluid pressure in the typical applications. The elastomeric component provides elastic properties to allow an energized stretch fit of the seal during installation without the need for a joint. The elimination of a joint avoids creation of a leak path that would be associated with such joint. The elastomeric component energizes the seal to provide a tight seal fit and further reduce leakage.

The elastomeric component includes a plurality of anti-rotation features that are spaced intermittently about a circumference of the elastomeric component. The anti-rotation features are configured on the elastomeric component to prevent rotational slippage in the application groove or bore that could negatively impact seal performance. The intermittent anti-rotation features are contoured to have substantially a “tear drop” shape to facilitate installation while providing improved grip to prevent slippage as compared to conventional configurations. The anti-rotation features also permit a thinner axial seal profile, which reduces seal volume fill, and which in turn reduces the radial seal force resulting in less drag and less heat generation about the seal as compared to conventional configurations. Less seal wear, therefore, occurs, thereby providing enhanced seal performance and longer seal life as compared to conventional configurations.

In accordance with the above features, an aspect of the invention is a shaft seal. In exemplary embodiments, the shaft seal includes an elastomeric component that includes a plurality of anti-rotation features spaced intermittently about a circumference of the elastomeric component, and a seal contact component that is bonded to the elastomeric component.

Another aspect of the invention is a shaft seal assembly. In exemplary embodiments, the shaft seal assembly includes the described shaft seal, and an application housing structure that defines a bore that receives at least a portion of the shaft seal. The seal contact component is received in the application housing structure adjacent a surface of the bore, and a portion of the application housing structure is configured to rotate relative to the shaft seal.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF DRAWINGS

FIG. 1 is a schematic diagram depicting a three-dimensional perspective view of an exemplary shaft seal in accordance with embodiments of the present invention, in which the elastomeric component is the outer diameter seal component.

FIG. 2 is a schematic diagram depicting a top view of the shaft seal of FIG. 1.

FIG. 3 is a schematic diagram depicting a side cross-sectional view of the shaft seal of FIGS. 1-2 along the line 3-3 of FIG. 2.

FIG. 4 is a schematic diagram depicting the portion of the shaft seal denoted by the oval indicator in FIG. 3.

FIG. 5 is a schematic diagram depicting another three-dimensional perspective view of an exemplary shaft seal in accordance with embodiments of the present invention, in which the elastomeric component is the inner diameter seal component.

FIG. 6 is a schematic diagram depicting a three-dimensional perspective view of an exemplary shaft seal assembly including a shaft seal and an application housing structure.

FIG. 7 is a schematic diagram depicting a cross-sectional view of the shaft seal assembly of FIG. 6.

FIG. 8 is a schematic diagram depicting the portion of the shaft seal assembly of FIG. 7 in the vicinity of the shaft seal.

FIG. 9 is a schematic diagram depicting a cross-sectional view of another exemplary shaft seal assembly including a shaft seal and an application housing structure.

FIG. 10 is a schematic diagram depicting the portion of the shaft seal assembly of FIG. 9 in the vicinity of the shaft seal.

### DETAILED DESCRIPTION

Embodiments of the present invention will now be described with reference to the drawings, wherein like reference numerals are used to refer to like elements throughout. It will be understood that the figures are not necessarily to scale.

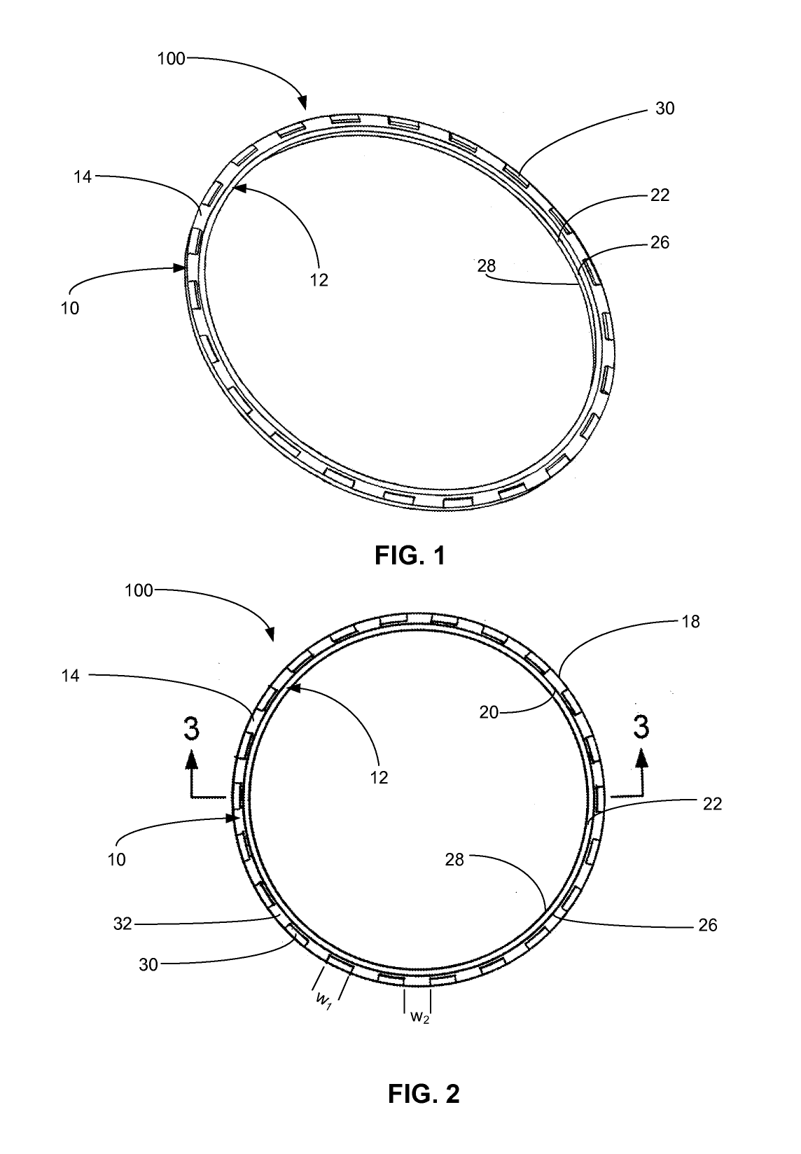

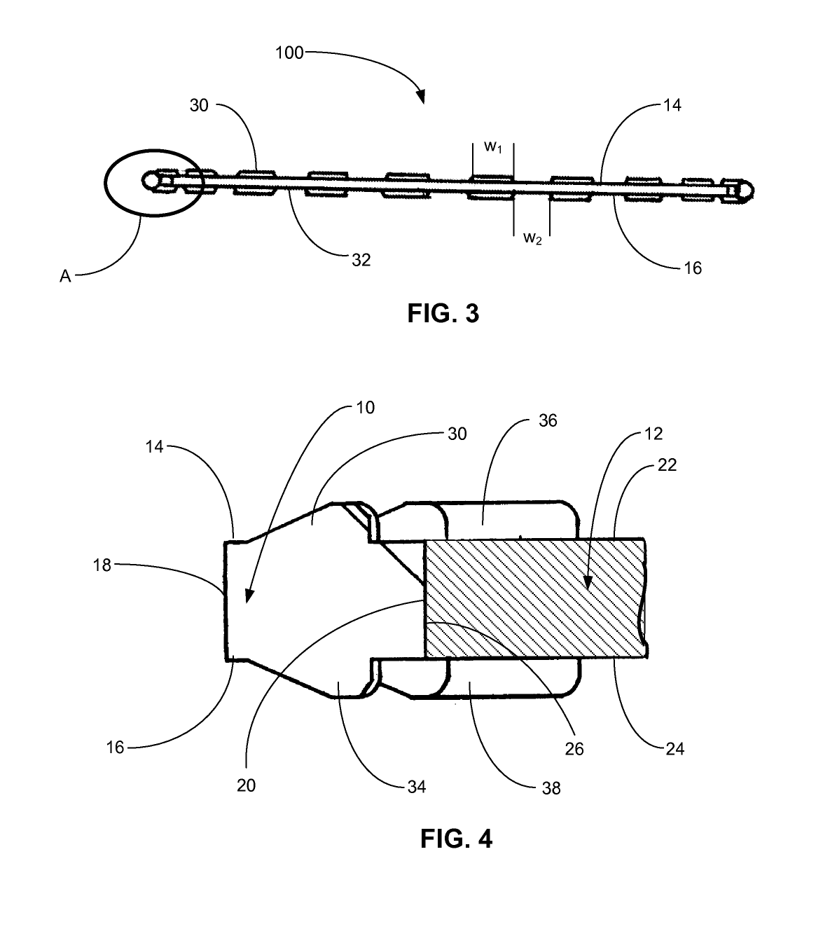

FIGS. 1-3 depict various views of an exemplary embodiment of a shaft seal 100 with a seal ring configuration. In particular, FIG. 1 is a schematic diagram depicting a three-dimensional perspective view of an exemplary shaft seal 100. FIG. 2 is a schematic diagram depicting a top view of the shaft seal 100 of FIG. 1, and FIG. 3 is a schematic diagram depicting a side cross-sectional view of the shaft seal 100 of FIGS. 1-2. The shaft seal 100 includes a first component 10 and a second component 12. The shaft seal has a ring structure, and the first and second components are ring structures that are concentrically adjacent each other. In this embodiment, the first component 10 is an elastomeric component, and the second component 12 is a non-elastomeric seal contact component. Accordingly, in this embodiment the elastomeric component 10 is the component provided as the outer diameter component of the shaft seal 100, and the seal contact component 12 is the component provided as the inner diameter component of the shaft seal 100.

The elastomeric component 10 may be made of any of a variety of suitable flexible, rubber-like materials. Suitable materials include, for example, various fluoro-elastomers, poly-acrylic materials, ethylene-acrylic materials, and like materials that are suitable to withstand the exposure to high pressure fluids and high heat of typical rotating shaft seal applications. Referring again to FIGS. 1-3, the elastomeric component 10 has a first or top axial face 14 and a second or bottom axial face 16 (best seen in FIG. 3). The elastomeric component 10 also has an outer diameter face 18 and an inner diameter face 20 (best seen in FIG. 2), which are perpendicular to the axial faces 14 and 16.

As the seal contact component, the seal contact component 12 is formed of a non-elastomeric material that rigid or semi-rigid. The material of the seal contact component 12 should be a low friction material relative to the rotating portion of a shaft or bore of an application housing structure. As further explained below, when positioned within the shaft or bore of the application housing structure, the low-friction nature of the seal contact component 12 permits near free rotation of the shaft of the application housing structure about the shaft seal 100. A suitable material for the seal contact component 12 is polytetrafluroethylene (PTFE), commonly sold under the trade name Teflon®. Similarly to the elastomeric component 10, the seal contact component 12 has a first or top axial face 22 and a second or bottom axial face 24. The seal contact component 12 also has an outer diameter face 26 and an inner diameter face 28 (best seen in FIG. 2), which are perpendicular to the axial faces 22 and 24.

At a boundary between the inner diameter face 20 of the elastomeric component 10, and the outer diameter face 26 of the seal contact component 12, the two components may be chemically bonded. A suitable chemical bond may be achieved by employing a heat-activated adhesive material as are known in the art. The shaft seal 100 may be formed by a co-molding process in which the components 10 and 12 are molded in a unitary process with the heat-activated adhesive. Such co-molding processes are known in the art of formation of seals and are suitable for use with the elastomeric and PTFE materials, and like suitable materials, described herein.

Referring again to FIGS. 1-3, the first or elastomeric component 10 further includes a plurality of anti-rotation features 30 spaced intermittently about a circumference of the elastomeric component. The plurality of anti-rotation features 30 may be formed on at least one of the first or second (top or bottom) axial faces 14 or 16. In an exemplary embodiment, as seen for example in the cross-sectional view of FIG. 3, the anti-rotation features may be formed on both of the axial faces 14 and 16. The anti-rotation features 30 may be ribs or like structures that are molded unitarily as part of a molding process that forms the elastomeric component 10.

In the embodiment of FIGS. 1-3, the plurality of anti-rotation features 30 are spaced intermittently about the circumference of the elastomeric component 10. In the embodiment depicted, for example, in FIGS. 1-3, each of the plurality of anti-rotation features 30 is spaced equidistant from each adjacent anti-rotation feature around the circumference of the elastomeric component 10. In addition, as seen particularly in the examples of FIGS. 2 and 3, each of the plurality of anti-rotation features 30 has an equal first width w₁. In addition, the elastomeric component includes spaces 32 between each of the plurality of anti-rotation features 30. Each space 32 has a second width w₂, and w₁ equals w₂. In one particular example, w₁ and w₂ both equal one quarter inch. The diameter of the elastomeric component and seal contact components will vary depending upon the application, and therefore for a fixed value of w₁/w₂, the number of anti-rotation features will vary based on the diameter of the seal components. It will be appreciated that these examples may be varied. A variety of values for w₁ and w₂ may be employed, and thus the width of the anti-rotation features 30 and spaces 32 may vary. In addition, although the anti-rotation features are spaced equidistant from each other in the above example, varied spacing between the anti-rotation features may be employed.

The configuration of the described elastomeric component 10, including the anti-rotation features 30 spaced intermittently about the circumference, has advantages over singular, circumferential conventional anti-rotation features provided in current shaft seal rings. The intermittent configuration of the anti-rotation features 30 provides for enhanced gripping force as compared to conventional anti-rotation features in the form of continuous interference rings. In addition, the intermittent configuration of the anti-rotation features 30 has a reduced seal volume, and thus an increased void volume in the application housing structure. This reduces drag forces and wear as compared to conventional configurations, and reduces the potential for over-stuffing of seal material within the shaft that often occurs with conventional anti-rotation features of shaft seal rings.

FIG. 4 is a schematic diagram depicting the portion of the shaft seal 100 denoted by the oval indicator A in FIG. 3. Portions of the elastomeric component 10 and seal contact component 12 are labeled in FIG. 4 comparably as in FIGS. 1-3. FIG. 4 depicts the structure of the elastomeric component 10, including an anti-rotation feature 30, in more detail.

As seen in FIG. 4, the anti-rotation features 30 may be provided in the form of a rib structure 34 that extends from adjacent the outer diameter face 18 and widens toward the inner diameter face 20. In a direction extending from the outer diameter face 18, the rib structure 34 may widen with a curvature that approximates or forms substantially a “tear drop” shape. The tear drop shape is particularly suitable for easy installation and fit, and provides sufficient axial interference with the application housing structure so as to prevent slippage of seal ring as referenced above.

Further referring to FIG. 4, as referenced above the inner diameter face 20 of the elastomeric component 10 is chemically bonded to the outer diameter surface 26 of the seal contact component 12. In the embodiment of FIG. 4, the elastomeric component 10 also may include opposite bonding elements 36 and 38 that are chemically bonded respectively to the first and second axial faces 22 and 24 of the seal contact component 12. In this manner, the inner diameter face 20 and the two bonding elements 36 and 38 of the elastomeric component 10 define a recess that receives the seal contact component 12 about its outer diameter surface 26.

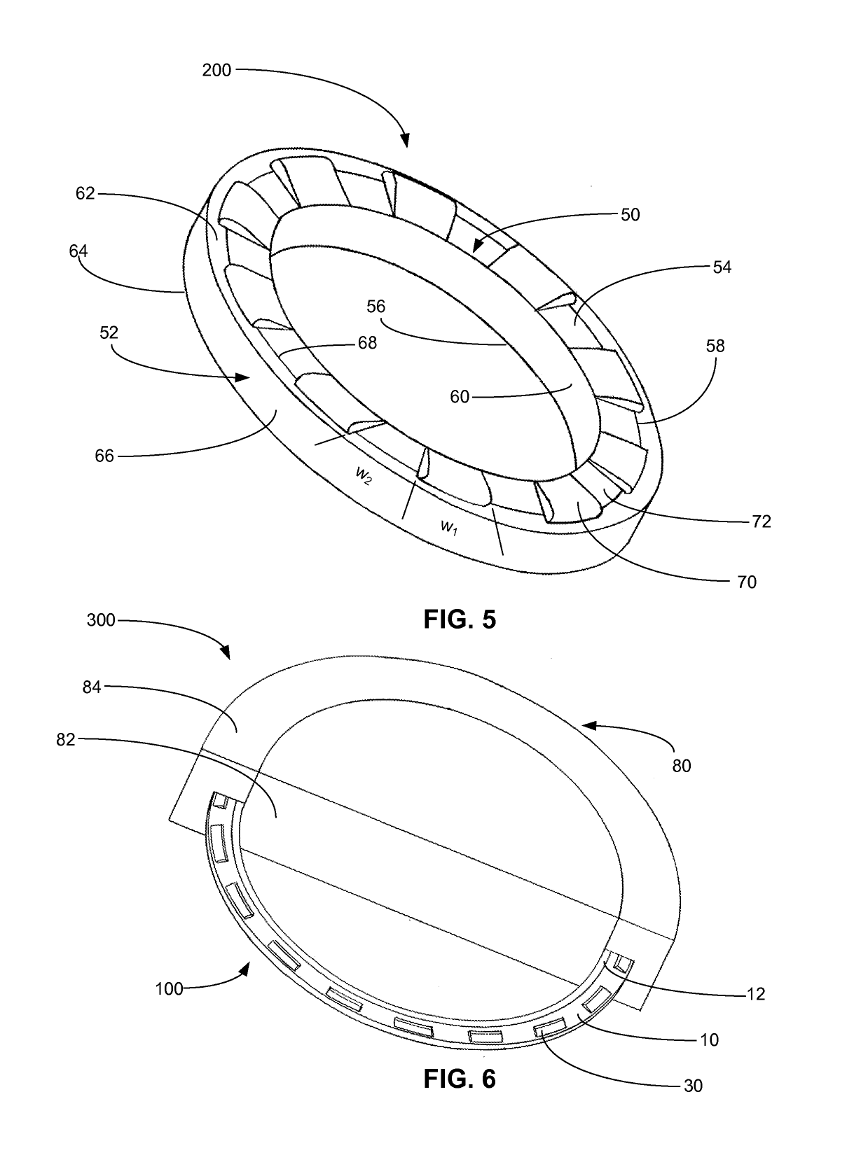

FIG. 5 is a schematic diagram depicting a three-dimensional perspective view of another exemplary embodiment of a shaft seal 200. Similarly to the previous embodiment, the shaft seal 200 includes a first component 50 and a second component 52. The shaft seal has a ring structure, and the first and second components again are concentric ring structures that are radially adjacent each other. In this embodiment, the first component 50 is an elastomeric component comparably structured as the elastomeric component 10, and the second component 52 is a non-elastomeric (such as a PTFE) seal contact component 52 comparably structured as the seal contact component 12. In the embodiment of FIG. 5, however, the elastomeric component 50 is the component provided as the inner diameter component of the shaft seal 200, and the seal contact component 52 is the component provided as the outer diameter component of the seal 200.

As seen in FIG. 5, the elastomeric component 50 has a first or top axial face 54 and a second or bottom axial face 56 (the underside face opposite face 54). The elastomeric component 50 also has an outer diameter face 58 and an inner diameter face 60, which are perpendicular to the axial faces 54 and 56. Similarly to the elastomeric component 50, the seal contact component 52 has a first or top axial face 62 and a second or bottom axial face 64 (the underside face opposite face 62). The seal contact component 52 also has an outer diameter face 66 and an inner diameter face 68, which are perpendicular to the axial faces 62 and 64. The two components may be chemically bonded, whereby the outer diameter face 58 of the elastomeric component 50 is chemically bonded to the inner diameter face 68 of the seal contact component 52 comparably as in the previous embodiment. As further explained below, when positioned within the shaft or bore of the application housing structure, the low-friction nature of the seal contact component 52 permits near free rotation of the shaft about the outer diameter face 66 of the seal contact component 52.

Similarly to the previous embodiment, the elastomeric component 50 further includes a plurality of anti-rotation features 70 formed on at least one of the first or second (top or bottom) axial faces 56 or 58. In an exemplary embodiment, the anti-rotation features may be formed on both of the axial faces 56 and 58. The anti-rotation features 70 also may be ribs or like structures that are molded unitarily as part of a molding process that forms the elastomeric component 50. The anti-rotation features 70 are spaced intermittently about the circumference of the elastomeric component 50. As in the previous embodiment, each anti-rotation feature 70 may be spaced equidistant from adjacent anti-rotation features around the circumference of the elastomeric component 50. In addition, as seen in FIG. 5, a first width w₁ of each anti-rotation feature 70 is equal to a second width w₂ of spaces 72 of the elastomeric component 50 between the anti-rotation features 70. Generally, the anti-rotation features of the embodiment of FIG. 5 may be spaced and configured comparably as in the previous embodiment and varied.

As seen in FIG. 5, the anti-rotation features 70 also may have a rib structure that approximates or substantially is a “tear drop” shape comparably as in the previous embodiment. In the embodiment of FIG. 5, the rib structure of each of the plurality of anti-rotation features 70 extends from adjacent the inner diameter face 60 and widens toward the outer diameter face 58, essentially opposite to the previous embodiment.

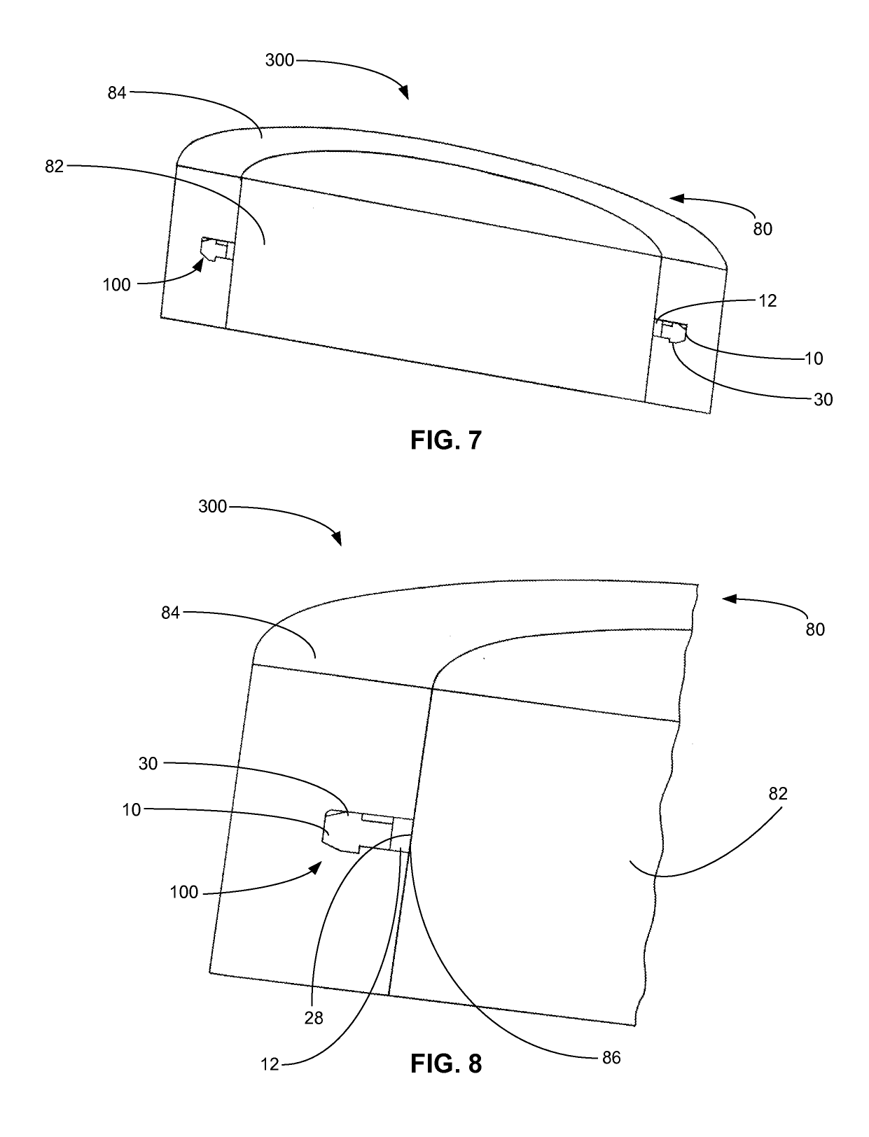

FIG. 6 is a schematic diagram depicting a three-dimensional perspective view of an exemplary shaft seal assembly 300. FIG. 7 is a schematic diagram depicting a cross-sectional view of the shaft seal assembly 300 of FIG. 6, and

FIG. 8 is a schematic diagram depicting the portion of the shaft seal assembly 300 of FIG. 7 in the vicinity of the shaft seal. The shaft seal assembly 300 includes a shaft seal comparable to the shaft seal 100 of FIGS. 1-4, contained within an application housing structure 80. Like components of the shaft seal 100 are labeled comparably in FIGS. 6-8 as in the above FIGS. 1-4. As described above as to such embodiment, in the shaft seal 100 the elastomeric component 10 is the outer diameter component relative to the seal contact component 12 being the inner diameter component.

The shaft seal 100 is located within the application housing structure 80 of the shaft seal assembly 300. The application housing structure 80 includes a housing contact component 82 and a seal housing 84. The components of the application housing structure define a recess shaft or bore for receiving the shaft seal 100. When placed within the application housing structure, the elastomeric component 10 is compressed to energize the seal. In addition, the semi-rigid nature of PTFE materials, as commonly used for the seal contact component 12, permits some small degree of additional flexibility to aid insertion and further energize the seal.

As described above, the anti-rotation features 30 are spaced intermittently about the circumference of the seal component 10. The intermittent configuration of the anti-rotation features 30 provides for an enhanced gripping force with the seal housing 84. In addition, as depicted best in FIG. 8, the inner diameter face 28 of the seal contact component 12 provides a contact surface with a corresponding contact surface 86 that is a portion of the outer diameter of the housing contact component 82. As described above, the material of the seal contact component 12 should be a low friction material relative to a shaft or bore of an application housing structure, as formed particularly by the housing contact component 82 of FIGS. 6-8. This low-friction nature permits near free rotation of the seal contact component 12 of the shaft seal 100 relative to the housing contact component 82 of the application housing structure 80.

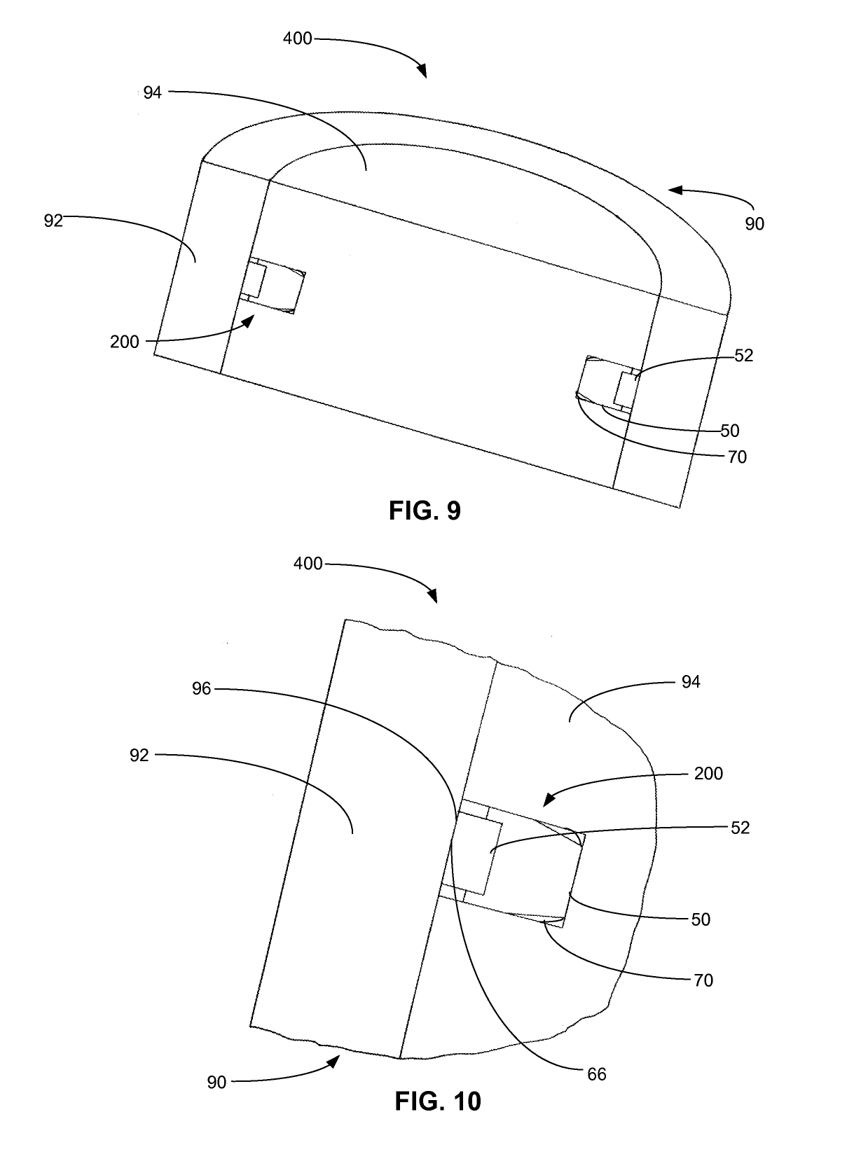

FIG. 9 is a schematic diagram depicting a cross-sectional view of an exemplary shaft seal assembly 400. FIG. 10 is a schematic diagram depicting the portion of the shaft seal assembly 400 of FIG. 9 in the vicinity of the shaft seal. The shaft seal assembly 400 includes a shaft seal comparable to the shaft seal 200 of FIG. 5, contained within an application housing structure 90. Like components of the shaft seal 200 are labeled comparably in FIGS. 9-10 as in the above FIG. 5. As described above as to such embodiment, in the shaft seal 200 the elastomeric component 50 is the inner diameter component relative to the seal contact component 52 being the outer diameter component.

The shaft seal 200 is located within the application housing structure 90 of the shaft seal assembly 400. The application housing structure 90 includes a housing contact component 92 and a seal housing 94. The components of the application housing structure define a recess shaft or bore for receiving the shaft seal 200. As in the previous embodiment, when placed within the application housing structure, the elastomeric component 50 is compressed to energize the seal. In addition, the semi-rigid nature of PTFE materials, as commonly used for the seal contact component 52, permits some small degree of additional flexibility to aid insertion and further energize the seal. In the embodiment of FIGS. 9 and 10, the housing contact component 92 is the outer diameter component of the application housing structure 90, and the seal housing 94 is the inner diameter component of the application housing structure 90 (the reverse positions as compared to the embodiment of FIGS. 6-8).

As described above, the anti-rotation features 70 are spaced intermittently about the circumference of the elastomeric component 50. The intermittent configuration of the anti-rotation features 70 provides for an enhanced gripping force with the seal housing 94. In addition, as seen best in FIG. 10, the outer diameter face 66 of the seal contact component 52 provides a contact surface with a corresponding contact surface 96 that is a portion of the inner diameter of the housing contact component 92. As described above, the material of the seal contact component 52 should be a low friction material relative to a shaft or bore of the application housing structure, as formed particularly by the housing contact component 92 of FIGS. 9-10. This low-friction nature permits near free rotation of the seal contact component 52 of the shaft seal 200 relative to the housing contact component 92 of the application housing structure 90.

In accordance with the above features, an aspect of the invention is a shaft seal. In an exemplary embodiment, the shaft includes an elastomeric component that includes a plurality of anti-rotation features spaced intermittently about a circumference of the elastomeric component, and a seal contact component that is bonded to the elastomeric component.

In another exemplary embodiment of the shaft seal, the elastomeric component includes a first axial face and a second axial face, and the anti-rotation features are formed on at least one of the axial faces of the elastomeric component.

In another exemplary embodiment of the shaft seal, the anti-rotation features are formed on both of the axial faces of the elastomeric component.

In another exemplary embodiment of the shaft seal, each of the plurality of anti-rotation features is spaced equidistant from each adjacent anti-rotation feature around the circumference of the elastomeric component.

In another exemplary embodiment of the shaft seal, each of the plurality of anti-rotation features has an equal first width w₁.

In another exemplary embodiment of the shaft seal, the elastomeric component includes spaces between each of the plurality of anti-rotation features, and each space has a second width w₂, and w₁ equals w₂.

In another exemplary embodiment of the shaft seal, each of the plurality of anti-rotation features is a rib structure.

In another exemplary embodiment of the shaft seal, the elastomeric component includes an outer diameter face and an inner diameter face, and the rib structure of each of the plurality of anti-rotation features extends from adjacent the outer diameter face and widens toward the inner diameter face.

In another exemplary embodiment of the shaft seal, the rib structure of each of the plurality of anti-rotation features substantially has a tear drop shape.

In another exemplary embodiment of the shaft seal, the elastomeric component includes an outer diameter face and an inner diameter face, and the rib structure of each of the plurality of anti-rotation features extends from adjacent the inner diameter face and widens toward the outer diameter face.

In another exemplary embodiment of the shaft seal, the rib structure of each of the plurality of anti-rotation features substantially has a tear drop shape.

In another exemplary embodiment of the shaft seal, the seal contact component is a non-elastomeric material that is rigid or semi-rigid.

In another exemplary embodiment of the shaft seal, the seal contact component is composed of polytetrafluroethylene (PTFE).

In another exemplary embodiment of the shaft seal, the elastomeric component is chemically bonded to the seal contact component.

In another exemplary embodiment of the shaft seal, the shaft seal has a ring structure, and the elastomeric component and the seal contact component are concentric ring structures.

In another exemplary embodiment of the shaft seal, the shaft seal has a ring structure, the elastomeric component and the seal contact component are concentric ring structures, and the elastomeric component is provided as the outer diameter component of the shaft seal.

In another exemplary embodiment of the shaft seal, the shaft seal has a ring structure, the elastomeric component and the seal contact component are concentric ring structures, and the elastomeric component is provided as the inner diameter component of the shaft seal.

Another aspect of the invention is a shaft seal assembly. In an exemplary embodiment, the shaft seal assembly includes the described shaft seal, and an application housing structure that defines a bore that receives at least a portion of the shaft seal.

In another exemplary embodiment of the shaft seal assembly, the seal contact component is received in the application housing structure adjacent a surface of the bore, and a portion of the application housing structure is configured to rotate relative to the shaft seal.

In another exemplary embodiment of the shaft seal assembly, the plurality of anti-rotation features provides a gripping force against a portion of the application housing structure.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

1. A shaft seal comprising:
an elastomeric component that includes a plurality of anti-rotation features spaced intermittently about a circumference of the elastomeric component; and
a seal contact component that is bonded to the elastomeric component.

2. The shaft seal of claim 1, wherein the elastomeric component includes a first axial face and a second axial face, and the anti-rotation features are formed on at least one of the axial faces of the elastomeric component.

3. The shaft seal of claim 2, wherein the anti-rotation features are formed on both of the axial faces of the elastomeric component.

4. The shaft seal of claim 1, wherein each of the plurality of anti-rotation features is spaced equidistant from each adjacent anti-rotation feature around the circumference of the elastomeric component.

5. The shaft seal of claim 4, wherein each of the plurality of anti-rotation features has an equal first width w₁.

6. The shaft seal of claim 5, wherein the elastomeric component includes spaces between each of the plurality of anti-rotation features; and
wherein each space has a second width w₂, and w₁ equals w₂.

7. The shaft seal of claim 1, wherein each of the plurality of anti-rotation features is a rib structure.

8. The shaft seal of claim 7, wherein the elastomeric component includes an outer diameter face and an inner diameter face, and the rib structure of each of the plurality of anti-rotation features extends from adjacent the outer diameter face and widens toward the inner diameter face.

9. The shaft seal of claim 8, wherein the rib structure of each of the plurality of anti-rotation features substantially has a tear drop shape.

10. The shaft seal of claim 7, wherein the elastomeric component includes an outer diameter face and an inner diameter face, and the rib structure of each of the plurality of anti-rotation features extends from adjacent the inner diameter face and widens toward the outer diameter face.

11. The shaft seal of claim 10, wherein the rib structure of each of the plurality of anti-rotation features substantially has a tear drop shape.

12. The shaft seal of claim 1, wherein the seal contact component is a non-elastomeric material that is rigid or semi-rigid.

13. The shaft seal of claim 12, wherein the seal contact component is composed of polytetrafluroethylene (PTFE).

14. The shaft seal of claim 1, wherein the elastomeric component is chemically bonded to the seal contact component.

15. The shaft seal of claim 1, wherein the shaft seal has a ring structure, and the elastomeric component and the seal contact component are concentric ring structures.

16. The shaft seal of claim 1, wherein the shaft seal has a ring structure, the elastomeric component and the seal contact component are concentric ring structures, and the elastomeric component is provided as the outer diameter component of the shaft seal.

17. The shaft seal of claim 1, wherein the shaft seal has a ring structure, the elastomeric component and the seal contact component are concentric ring structures, and the elastomeric component is provided as the inner diameter component of the shaft seal.

18. A shaft seal assembly comprising:
the shaft seal of claim 1; and
an application housing structure that defines a bore that receives at least a portion of the shaft seal.

19. The shaft seal assembly of claim 18, wherein the seal contact component is received in the application housing structure adjacent a surface of the bore, and a portion of the application housing structure is configured to rotate relative to the shaft seal.

20. The shaft seal assembly of claim 19, wherein the plurality of anti-rotation features provides a gripping force against a portion of the application housing structure.
